(19) United States
(12) Patent Application Publication
(10) Pub. No.: US 2005/0242261 A1
(43) Pub. Date: Nov. 3, 2005

(54) Surgical suspension system

(75) Inventors: Manfred Brahler, Grossenluder (DE); Klaus Steger, Eiterfled (DE)

Correspondence Address: Thomas E. Kocovsky, Esq.;Fay, Sharpe, Fagan, Minnich & McKee, LLP, Seventh Floor, 1100 Superior Avenue, Cleveland, OH, 44114-2518, US

(73) Assignees: STERIS INC; Ondal Industrietechnik GmbH

(21) Appl. No.: 11/054,170

(22) Filed: Feb. 9, 2005

Related U.S. Application Data
(63) Continuation-in-part of application No. 10/373,918, filed on Feb. 25, 2003.
(60) Provisional application No. 60/359,518, filed on Feb. 25, 2002.

(51) Int. Cl. F16F 9/34; A47H 1/10

(52) U.S. Cl. 248/326; 248/327; 248/333

(57) ABSTRACT

A suspension system is disclosed for suspending lightheads, monitors, cameras, or other medical apparatus from an overhead structure at a selectable height. A drop tube has a selected portion thereof surroundingly encompassed by a receiving element that has a variable inside diameter substantially conforming to a frustum of a cone. A mounting plate rigidly connects with the overhead structure and with the receiving element. The mounting plate has an opening through which an end of the drop tube passes. A wedge-shaped element has an overall variable outer diameter substantially conforming to a frustum of a cone and includes a lower threaded tapered region. The wedge-shaped element compressively inserts into the receiving element through tightening of a nut on the threaded tapered region. The element surroundingly encompasses the selected portion of the drop tube to effectuate a compressive clamping of the selected portion of the drop tube inside the receiving element.

This application is a continuation-in-part application of application Ser. No. 10/373,918 filed Feb. 25, 2003, still pending, which claims the benefit of U.S. Provisional Application No. 60/359,518, filed Feb. 25, 2002.

### BACKGROUND OF THE INVENTION

The present invention relates to the suspension system arts. It particularly relates to suspension systems for surgical operating room lightheads, monitors, cameras, and the like, and will be described with particular reference thereto. However, the invention will also find application in other ceiling-mounted apparatus and in fields outside the medical industry.

In operating theaters, intensive care rooms, and other hospital and clinical settings, medical equipment, such as overhead lighting and monitoring devices, is carried from overhead by suspension systems extending downward from a ceiling. This arrangement advantageously places the equipment out of the way of busy medical personnel and yet readily accessible when needed. Suspended lighting, for example, can effectively illuminate the surgical site without physically interfering with the surgeon.

Such suspension systems usually include a mounting plate (sometimes called a “cheese plate”) attached to a rigid overhead structure, a drop tube connected to the mounting plate, a rotatable spindle fixed to the drop tube which allows rotation about a vertical axis, and one or a plurality of extension and/or articulating arms which connect with and support equipment such as surgical lightheads, monitors, cameras, or other devices. The articulating arms are often multiply jointed to permit several degrees of mechanical freedom for the attached device.

The connection of the drop tube to the mounting plate most often uses a tube-in-tube design wherein the drop tube is fixed to a cylinder which is in turn fixed to the mounting plate using screws or other suitable fasteners. Because ceiling heights at various installations such as hospitals and clinics vary from one facility to another, and because the suspension system preferably accommodates placement of medical devices in ergonomically acceptable positions for medical personnel relative to the floor, the suspension systems are advantageously adaptable for different ceiling heights.

However, existing suspension systems typically use a drop tube having a fixed length. Height adjustment of the overall system is accomplished either by selecting a drop tube of an appropriate standard or custom length, or by cutting the tube at the installation site and drilling the necessary holes into the tube at the proper locations to effect secure attachment.

Providing preselected custom length drop tubes that are pre-cut at the factory to match the ceiling height disadvantageously introduces logistical problems, long lead times, and the possibility that the drop tubes will not fit with the actual relative ceiling to floor spacing.

Cutting a tube at the installation site risks poorly executed cutting and/or drilling of the tube resulting in a damaged suspension system and possible safety issues. Another disadvantage of cutting the tube at the installation site is that it is usually not possible to machine properly the end of the tube which is cut. The rough cut end is accommodated by including relatively large tolerances for the tube-in-tube connection and may require adjustment screws or the like. However, abnormal clearances can nonetheless result and cannot always be corrected by the adjustment screws.

Yet another disadvantage of existing suspension systems is that the height of the finished system is not S subsequently adjustable in the vertical direction. Thus, when the suspension system is moved to a different operating theater having a different ceiling height the drop tube is either replaced or, if the new operating theater has a lower ceiling, re-cut to accommodate the lower ceiling.

The present invention contemplates an improved surgical suspension apparatus which overcomes the aforementioned limitations and others.

### SUMMARY OF THE INVENTION

According to one aspect of the invention, a suspension system is disclosed for suspending one or more devices, such as lightheads, monitors, cameras, or other medical apparatus, from an overhead structure at a selectable height. A drop tube has a selected portion thereof surroundingly encompassed by a receiving element that preferably has a variable inside diameter substantially conforming to a frustum of a cone. A mounting plate rigidly connects with the overhead structure and with the receiving element. The mounting plate has an opening through which an end of the drop tube passes. A wedge-shaped element has a variable outer diameter substantially conforming to a frustum of a cone. The wedge-shaped element compressively inserts into the receiving element and surroundingly encompasses the selected portion of the drop tube to effectuate a compressive clamping of the selected portion of the drop tube inside the receiving element.

According to another aspect of the invention, a device mounting system is disclosed. A securing element, rigidly connects with an associated overhead fixed structure. A drop tube has a first end that extends through an opening in the securing element. A wedge-shaped locking tube slidably receives the drop tube. The wedge-shaped locking tube compressively inserts into the opening of the securing element to effectuate a compressive locking between the securing element and a selected portion of the drop tube. An articulating arm is disposed at a second end of the drop tube. The articulating arm has at least one adjustable joint, and also has an attachment end adapted to receive an associated device.

According to yet another aspect of the invention, a mounting post is disclosed that adjustably extends downward from an overhead structure. A mounting plate is arranged a selected distance below the associated overhead structure and is rigidly connected therewith. The mounting plate has a drop tube opening. A drop tube passes through the drop tube opening at a selected point along the drop tube. The drop tube has a proximal end extending upward above the drop tube opening and a distal end extending downward below the drop tube opening. A collar is surroundingly arranged over the drop tube at the selected point. The collar includes an outer surface of narrowing diameter terminating at a narrow end. The outer surface compressively wedges at least partially into the drop tube opening. The collar also includes an inner surface which compresses against the drop tube at the selected point responsive to the wedging to secure the drop tube in the drop tube opening at the selected point.

According to yet another aspect of the invention, a method of variably adjusting a distance, relative to a fixed surface, of a distal end of a drop tube for supporting a medical device is provided. The method includes rigidly supporting a receiving element from the fixed surface, loosely inserting a collar into a bore of the receiving element, inserting the drop tube into the collar such that an end of the drop tube extends a selected distance below the receiving element, and drawing the collar into the receiving element bore such that the drop tube is compressively clamped by the receiving element and collar.

One advantage of the present invention resides in the enablement of continuous height adjustment over a range of positions in installing a surgical suspension system.

Another advantage of the present invention is the ability to adapt the suspension system height to different surgical theaters or other ceiling height changes.

Another advantage of the present invention resides in the elimination of circumferential tube-in-tube fitting clearances which are replaced in the preferred embodiment of the invention by a compressed wedge element that surroundingly clamps onto the drop tube.

Yet another advantage of the present invention is the elimination of on-site installation work including precision tube cutting and drilling. The drop tube can be “rough cut” at the installation site to provide a desired nominal tube length, but precision machining is not necessary.

Still yet another advantage of the present invention is the elimination of a precise length specification in preselected custom length drop tubes.

Numerous additional advantages and benefits of the present invention will become apparent to those of ordinary skill in the art upon reading the following detailed description of the preferred embodiment.

### BRIEF DESCRIPTION OF THE DRAWINGS

The invention may take form in various components and arrangements of components, and in various steps and arrangements of steps. The drawings are only for the purpose of illustrating preferred embodiments and are not to be construed as limiting the invention.

FIG. 1 shows a plurality of medical devices including lightheads and monitoring equipment connected to a suspension system formed in accordance with an embodiment of the invention;

FIG. 2 shows an exploded sectional view of a suspension system formed in accordance with an embodiment of the invention;

FIG. 2a is an enlarged showing of the circled area of FIG. 2;

FIG. 3 shows an assembled sectional view of the suspension system of FIG. 2;

FIG. 4 shows an exploded perspective view of the suspension system of FIGS. 2 and 3 with additional ornamental cover plate and connecting components; and

FIG. 5 shows an assembled view, in partial section, of the suspension system of FIG. 3 with a safety ring assembly attached to the drop tube.

### DETAILED DESCRIPTION OF THE PREFERRED EMBODIMENTS

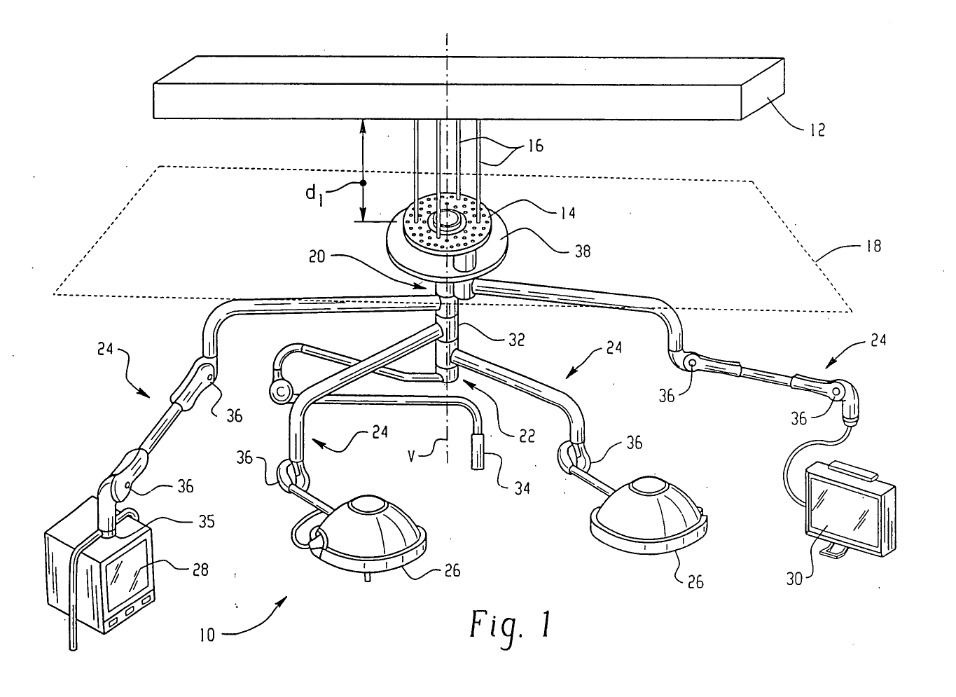

With reference to FIG. 1, an overhead lighting system 10 is mounted from a fixed overhead structure 12 which in the illustrated case is an overhead beam 12. A mounting plate or “cheeseplate” 14 is secured at a selected distance d₁ below the overhead structure 12 by a plurality of long-shank fasteners 16. Typically, the distance d₁ corresponds to a distance of an operating room ceiling 18 below the structural component 12.

A drop tube 20 connects at a proximal end to the mounting plate 14 and has a distal end 22 extending downward. One or more articulating arms 24 are disposed at the distal end 22. Each articulating arm 24 has a medical device, such as a lighthead 26, CRT monitor 28, flat panel monitor 30, manual task light 34, or the like attached at a distal end 35. Typically, the proximal end of each articulating arm 24 connects to the drop tube 20 via a rotatable spindle 32 which is rotatable about a vertical axis V. Each articulating arm 24 usually includes one or multiple joints 36 which are adjustable about one or more axes each to provide additional degrees of motion freedom.

The overhead lighting system 10 optionally includes additional features, such as a cosmetic ceiling cover 38. Those skilled in the art will also appreciate that the system 10 can be employed for mounting a wide range of other devices in addition to the lightheads and monitors illustrated, such as cameras, fiber optical light pipes, and the like. It will further be appreciated that the overhead lighting system 10 is not limited in application to surgical theaters, or even to medical or clinical settings. The overhead mounting of devices is beneficial in any setting where it is advantageous to have devices conveniently accessible and yet not “in the way” of people's usual movements.

An important parameter of the overhead lighting system 10 is the height of the distal end 22 of the drop tube 20 relative to the floor. For example, many surgical lightheads include reflectors designed to reflect light around the surgeon's head. The lighthead is thus positioned behind the surgeon's head, and the light reflects around the surgeon's head and onto or into the surgical opening. The precise positioning of the lighthead relative to the surgeon's head is thus critical, and improper positioning can result in partial blockage of the illumination by the surgeon's head, or a collision. Similarly, the monitors 28, 30 should be placed at an ergonomically advantageous position so that the surgeon can easily view the monitors during the operation, with the ability to glance back-and-forth between the surgical opening and the monitors.

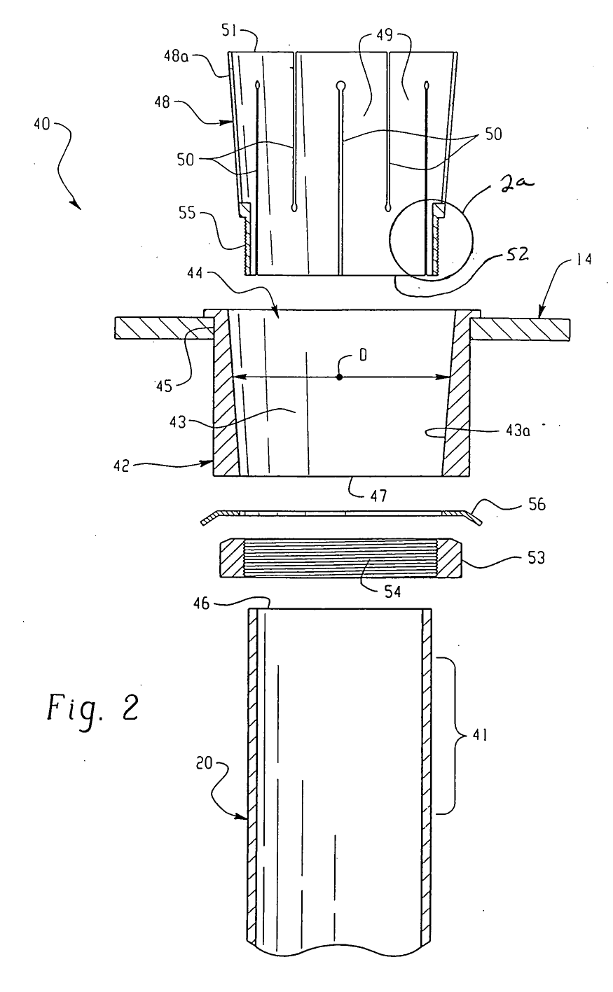

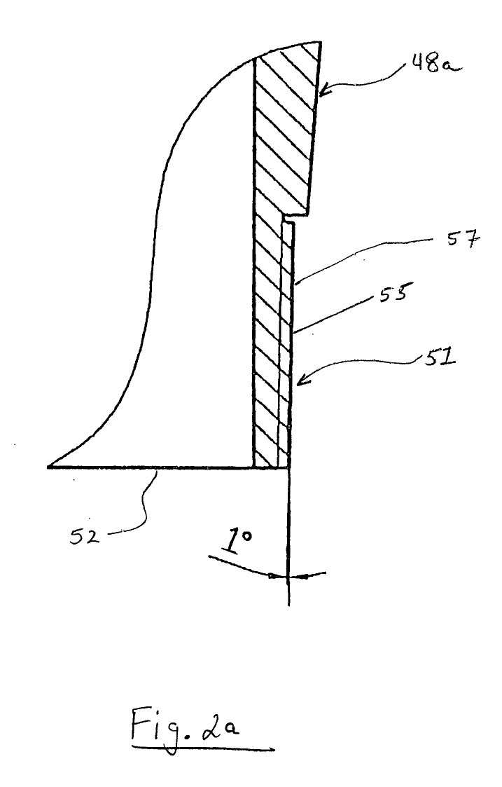

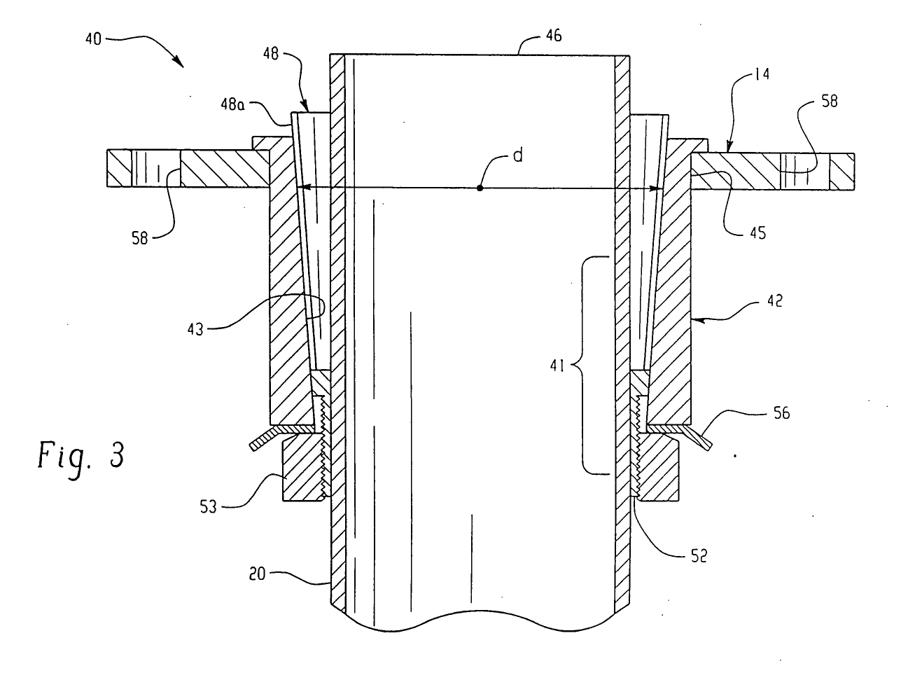

With reference to FIGS. 2, 2a and 3, an adjustably positionable drop tube locking mechanism 40 is described. The locking mechanism 40 selectively clamps an intermediate portion 41 of the drop tube between the distal and proximal ends. The locking mechanism includes a drop tube receiving element in the form of a cylinder 42 with an axially extending bore 43, with an interior wall surface 43a, which defines an upper opening 44. The bore 43 preferably has an inner diameter D which decreases, towards a lower end. The cylinder is thus internally shaped as a frustum of a cone and is rigidly attached inside a centrally located opening 45 of the mounting plate 14, for example by welding. The mounting plate 14 together with the welded cylinder 42 provide a securing element 14, 42 for rigidly securing the drop tube 20 (shown in part in FIGS. 2 and 3). As best seen in the assembled view of FIG. 3, the drop tube 20 passes through the opening 44 and narrowing bore 43. The drop tube 20 has a distal end 22 (FIG. 1) extending downward below the cylinder 42, and a proximal end 46 extending upward adjacent the cylinder 42. The drop tube 20 has a smaller outer diameter than the narrowest portion of the narrowing bore 43 and is therefore adjustably positionable within the cylinder 42 with its distal end 22 extending a selected distance below a lower narrow open end 47 of the bore.

Although a separate drop tube receiving element, namely the cylinder 42, is shown in the illustrated embodiment, it is also contemplated to form the mounting plate 14 and the cylinder 42 as a single integral piece. That is, in a contemplated alternative embodiment the mounting plate includes an opening corresponding to the opening 44. However, as can be discerned from FIGS. 2 and 3, such an alternative embodiment may include a thicker mounting plate.

With continuing reference to FIGS. 2, 2a, and 3, a substantially cylindrical locking tube or collar 48 surroundingly encompasses the drop tube 20. The cylindrical collar 48 defines a longitudinal axis V and is preferably wedge-shaped. It has an outside surface 48a with a diameter d which decreases toward a lower end thereof. The collar is thus essentially shaped as a frustum of a cone and is similarly sized to the similarly shaped narrowing bore 43 of the cylinder 42. The taper of the outer surface may be the same as the taper of the bore, although it is also contemplated that the taper may be somewhat greater or lesser than that of the bore. The collar 48 includes at least one and preferably a plurality of longitudinally extending slots 50 spaced apart along the outer surface of the collar 48. As shown in FIG. 2, some of the slots 50 extend downward from a wider or upper end 51 of the collar, while other slots extend upward from a narrow or lower end 52 of the collar, although it is also contemplated that the slots need not extend fully to either end 51, 52. The resiliently flexible strips 49 thus defined between the slots are able to flex inwardly when the collar 48 is exteriorly compressed. Where the strips 49 extend fully to one or other end 51, 52, this allows the free ends of the strips to move towards each other when the collar 48 is compressed.

The wedge-shaped collar 48 acts as a collet which passes through the cylinder opening 44 and is wedged into the bore 43, with the lower end 52, extending slightly beyond the lower open end 47 of the bore 43. The wedging compresses the collar 48, with the slots 50 facilitating the compression. During compression, both the inner and outer diameters of the collar decreases. As the collar 48 compresses, it presses against the drop tube 20 to effectuate a compressive clamping of the drop tube 20 inside the cylinder 42. The collar 48 is preferably formed from metal of a sufficient thickness for the strips 49 to flex inward when compressed and return to their original positions when released.

To enable a secure compressive locking, a tightening nut 53 (FIG. 2) preferably is used to draw the collar 48 into the bore 43 of the cylinder 42 downwardly as viewed in the Figure. The nut 53 is internally threaded at 54 and threadedly attaches to external threads 55 disposed on the narrow end 51 of the collar 48. As can be best seen from FIG. 2a, the narrow end 51 is slightly tapered, in the region of the threads. Thus, the threads 55 carried on the tapered narrow end 51 define a tapered outer surface 57. Preferably, the taper of the narrow end 51 and threads 55 is about one degree (1°). As the nut 53 is tightened, the collar 48 is compressively drawn into the opening 44 of the cylinder 42, downwardly as viewed in FIG. 2, to effectuate the compressive clamping. In place of threads, other means of tightening the nut onto the collar are also contemplated.

Optionally, a lock washer 56 is included to prevent the nut 53 from loosening. Furthermore, although a slotted wedge-shaped collar 48 is illustrated, other wedge-shaped elements are suitably substituted therefore as desired. For example, a collet or other type of locking tube is also contemplated. In another embodiment, only one of the collar 48 and cylinder 42 has a taper, for example, the cylinder bore 43 may have a constant diameter D while the collar is tapered, or the collar have a constant diameter d while the cylinder 42 is tapered.

FIG. 3 particularly illustrates the subject wedge lock mechanism 40 and selected suspension system components in their assembled configuration. As can be appreciated, by tightening the nut 53, the wedge 48 is drawn further into the narrowing bore 43 of the securing element 14, 42 and is clamped into place. The slots 50 within the wedge 48 allow the wedge 48 to compress and tighten around the outer surface of the drop tube 20. It is to be appreciated that as the collar 38 is drawn downwardly through tightening of the nut 53, the collar compresses radially inwardly whereby both the inner and outer diameters thereof are reduced. Therefore, the taper of the narrow end 51 and threads 55 carried thereon advantageously provide for a positive engagement with the internal threads 54 on the nut. Without the taper, preferably about one degree (1°), the outer threads 55 on the collar 48 can lose contact with the inner threads 54 on the nut 53 as the collar 48 collapses when drawn downwardly is viewed in the Figure. Thus, the taper compensates for the collapsing of the threads during tightening of the nut. The drop tube 20 is essentially thereby fixed within the wedge-shaped collar 48 and the cylinder 42 through frictional forces created between the component parts. The wedge lock mechanism 40 advantageously provides for continuous and repeatable height adjustment, by simply loosening the nut 53, sliding the drop tube 20 to its new position relative to the cylinder 42 and, more importantly, to the floor, and retightening the nut 53.

The length of drop tube 20 which extends below the cylinder 42 is thus infinitely variable between an upper position, in which the uppermost spindle 32 is flush with the nut 53, and a lower position, in which the upper end of the tube 20 is clamped by the collar. The excess, upper portion of the drop tube 20 is thus “stored” until needed within the cylinder 42 and may extend upward, into the space above the ceiling 18, thus providing for the portion of the drop tube below the cylinder 42 to be increased or decreased in length, as the need arises.

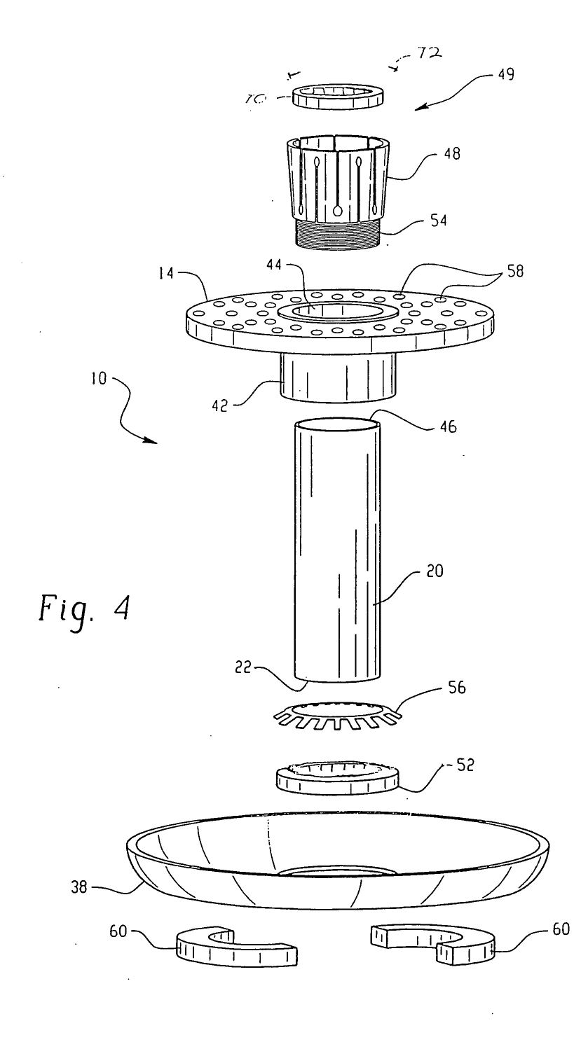

With continuing reference to FIGS. 1 through 3 and with further reference to FIG. 4 which shows a perspective exploded view of the suspension system 10, the suspension system 10 is connected using the fasteners 16 (FIG. 1) which insert into a selected plurality of the openings 58 in the cheeseplate 14. The cosmetic ceiling cover 38 (FIGS. 1 and 4) is secured by locking half-rings 60 (FIG. 4). Since the cosmetic ceiling cover 38 is not a weight-bearing component, the securing does not need to be particularly strong, and various securing components are contemplated in place of the rings 60.

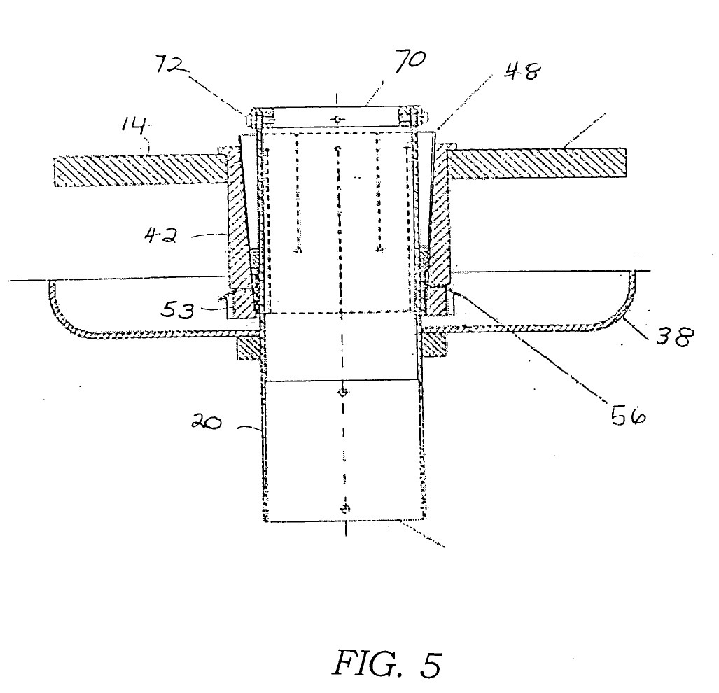

Preferably, a safety ring assembly 70 is provided to prevent the tube 20 from pulling through the collar 48 in the unlikely event that the system loosens. The safety ring assembly attaches to the tube 20 above the collar 48 using suitable fasteners 72, such as bolts, screws or the like (FIG. 5). In that way, if the tube 20 slides relative to the collar 48, contact is made between the split rings of the safety ring and the upper end of the tapered collar urging the collar into further compression against the tube and also mechanically preventing the tube from pulling through the collar.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A suspension system for suspending one or more medical apparatus from an overhead structure at a selectable height, the suspension system comprising:
a drop tube configured for supporting the one or more medical apparatus;
a cylindrical receiving element having a radially outwardly extending lip and an inside diameter which decreases toward a lower end thereof, the receiving element surroundingly encompassing a selected portion of the drop tube;
a mounting plate configured for mounting to the overhead structure, the mounting plate being connected with the receiving element through at least contact between the mounting plate and said lip, the mounting plate having an opening through which an end of the drop tube passes;
a wedge-shaped element having an outer diameter which decreases toward a lower end thereof, the wedge-shaped element compressively inserting into the receiving element and surroundingly encompassing the selected portion of the drop tube to effectuate a compressive clamping of the selected portion of the drop tube inside the receiving element, the wedge-shaped element having a tapered threaded portion; and,
a tightening nut adapted to thread onto said tapered threaded portion of the wedge-shaped element to compressively draw the wedge-shaped element into the receiving element.

2. The suspension system as set forth in claim 1 wherein:
-said wedge-shaped element is substantially cylindrical and defines a first longitudinal axis; and,
said tapered threaded portion is inclined relative to said first longitudinal axis by an angle of about one degree (1°).

3. The suspension system as set forth in claim 1, wherein the wedge-shaped element includes a plurality of longitudinally extending slots.

4. The suspension system as set forth in claim 1, wherein the largest outer diameter of the wedge shaped element is greater than the smallest inside diameter of the receiving element.

5. A device mounting system comprising:
a securing element having a radially extending lip configured for being rigidly connected with an associated overhead fixed structure;
a drop tube having a first end extending through an opening in the securing element;
a locking tube adapted to slidably receive the drop tube, the locking tube having a tapered threaded end and being selectively compressively insertable into the opening of the securing element to effectuate a compressive locking between the securing element and the drop tube;
a tightening nut adapted to threadedly cooperate with said tapered threaded end of the locking tube for drawing the locking tube into the opening of the securing element; and,
a rotatable spindle disposed at a second end of the drop tube.

6. The device mounting system as set forth in claim 5, wherein at least one of the securing element and the locking element has a tapered surface which engages a surface of the other of the securing element and the locking element.

7. The device mounting system as set forth in claim 5, further including an articulating arm attached to the rotatable spindle, the articulating arm having at least one adjustable joint and an attachment end adapted to receive an associated device.

8. The device mounting system as set forth in claim 5, wherein the attachment end is adapted to receive an associated device selected from the group consisting of lightheads, task lights, patient monitoring devices, equipment management systems, cameras, and combinations thereof.

9. The device mounting system according to claim 5, wherein:
said locking tube is substantially cylindrical and defines an axis; and
said threaded end of the locking tube defines a taper of about one degree (1°) relative to said axis.

10. The device mounting system as set forth in claim 5, wherein the securing element includes:
a mounting plate configured for being rigidly connected with the associated overhead fixed structure; and
a wedge-shaped collar rigidly attached to the mounting plate and having a narrowing tubular bore adapted to receive the locking tube, the locking tube being wedge-shaped.

11. The device mounting system as set forth in claim 5, wherein the locking tube includes a collet.

12. The device mounting system as set forth in claim 5, wherein the locking tube includes a plurality of slots arranged longitudinally along the locking tube.

13. A mounting post adjustably extending downward from an overhead structure, the mounting post comprising:
a mounting plate defining a lip portion and being arranged a selected distance below the associated overhead structure and rigidly connected therewith by said lip, the mounting plate having a drop tube opening;
a drop tube extending into the drop tube opening and having a proximal end and a distal end extending downward below the drop tube opening; and,
a collar surroundingly arranged over the drop tube at the selected point, the collar having:
an outer surface of narrowing diameter terminating at a tapered threaded narrow end, which outer surface compressively wedges at least partially into the drop tube opening, and
an inner surface which compresses against the drop tube at the selected point responsive to the wedging to secure the drop tube in the drop tube opening at the selected point.

14. The mounting post as set forth in claim 13, wherein the drop tube opening has a narrowing diameter arranged to substantially mate with at least a portion of the narrowing outer surface of the collar.

15. The mounting post as set forth in claim 13, wherein the mounting plate includes:
a cheeseplate member rigidly connected with the associated overhead structure by a plurality of associated fasteners, the cheeseplate including a central opening; and
a receiving tube secured within the central opening, the receiving tube having a narrowing inside diameter adapted to wedgingly receive the collar.

16. The mounting post as set forth in claim 13, further including:
a tightening nut adapted to threadedly connect with the tapered threaded narrow end of the collar, wherein the tapered threaded narrow end extends through the drop tube opening and tightening of the nut effectuates the wedging.

17. A method of variably adjusting a distance, relative to a fixed surface, of a distal end of a drop tube for supporting a medical device, the method comprising:
rigidly supporting a receiving element from the fixed surface by contact between a lip extending from the receiving element and said fixed surface;
loosely inserting a collar into a bore of the receiving element, the collar having a lower threaded region having a taper;
inserting the drop tube into the collar such that an end of the drop tube extends a selected distance below the receiving element; and
drawing the collar into the receiving element bore such that the drop tube is compressively clamped by the receiving element and collar by tightening an associated nut on said lower threaded region of the collar.

18. The method as set forth in claim 17, wherein:
the collar includes a plurality of longitudinally extending, spaced slots and said taper of said lower threaded region defines a taper angle of about 1°; and
S the step of drawing the collar into the bore includes compressing strips defined between the slots.

19. A clamping apparatus for use in a suspension system suspending medical apparatus from an overhead structure at a selectable height and including: a drop tube configured for supporting the medical apparatus, a cylindrical receiving element having a radially outwardly extending lip and an inside diameter which decreases toward a lower end thereof, the receiving element surroundingly encompassing a selected portion of the drop tube, and a mounting plate configured for mounting to the overhead structure, the mounting plate being connected with the receiving element through at least contact between the mounting plate and said lip, the mounting plate having an opening through which an end of the drop tube passes, the clamping apparatus comprising:
a wedge-shaped element having an outer diameter which decreases toward a lower end thereof, the wedge-shaped element compressively inserting into the receiving element and surroundingly encompassing the selected portion of the drop tube to effectuate a compressive clamping of the selected portion of the drop tube inside the receiving element, the wedge-shaped element having a tapered threaded portion; and,
a tightening nut adapted to thread onto said tapered threaded portion of the wedge-shaped element to compressively draw the wedge-shaped element into the receiving element.

20. The clamping apparatus as set forth in claim 19 wherein:
said wedge-shaped element is substantially cylindrical and define a first longitudinal axis; and,
said tapered threaded portion is inclined relative to said first longitudinal axis by an angle of about one degree (1°).

21. The clamping apparatus as set forth in claim 19, wherein the wedge-shaped element includes a plurality of longitudinally extending slots.

22. The clamping apparatus as set forth in claim 19, wherein the largest outer diameter of the wedge shaped element is greater than the smallest inside diameter of the receiving element.

23. A device mounting system comprising:
a securing element configured for being rigidly connected with an associated overhead fixed structure;
a drop tube having a first end extending through an opening in the securing element;
a locking tube adapted to slidably receive the drop tube, the locking tube having a plurality of slots arranged longitudinally along the locking tube and a tapered threaded end defining a taper of about one degree (1°), the locking tube being selectively compressively insertable into the opening of the securing element to effectuate a compressive locking between the securing element and the drop tube;
a tightening nut adapted to threadedly cooperate with said tapered threaded end of the locking tube for drawing the locking tube into the opening of the securing element; and,
a rotatable spindle disposed at a second end of the drop tube.

24. A collar for use with a mounting post adjustably extending downward from an overhead structure and including: a mounting plate defining a lip portion and being arranged a selected distance below the associated overhead structure and rigidly connected therewith by said lip, the mounting plate having a drop tube opening, and a drop tube extending into the drop tube opening and having a proximal end and a distal end extending downward below the drop tube opening, the collar surroundingly arranged over the drop tube at the selected point, the collar comprising:
an outer surface of narrowing diameter terminating at a tapered threaded narrow end, which outer surface compressively wedges at least partially into the drop tube opening; and, an inner surface which compresses against the drop tube at the selected point responsive to the wedging to secure the drop tube in the drop tube opening at the selected point.

25. The collar as set forth in claim 24, further including:
a tightening nut adapted to threadedly connect with the tapered threaded narrow end of the collar, wherein the tapered threaded narrow end extends through the drop tube opening and tightening of the nut effectuates the wedging.
